(19) United States
(12) Patent Application Publication
(10) Pub. No.: US 2006/0255568 A1
(43) Pub. Date: Nov. 16, 2006

(54) Fastening device for the installation and retention of an airbag at vehicle body

(76) Inventors: Otto Demel, Heidelberg (DE); Walter Kolb, Eppelheim (DE); Rainer Schroter, Reichertshausen (DE)

Correspondence Address: LADAS & PARRY LLP, 224 SOUTH MICHIGAN AVENUE, SUITE 1600, CHICAGO, IL, 60604, US

(21) Appl. No.: 11/408,296

(22) Filed: Apr. 21, 2006

(30) Foreign Application Priority Data
Apr. 22, 2005 (EP) 05290897.7

(51) Int. Cl. B60R 21/217

(52) U.S. Cl. 280/728.2

(57) ABSTRACT

A fastening element for the installation and retention of an airbag at the body of a vehicle. The fastening device is equipped with an essentially flat first element component for the immediate fastening of the airbag to the body, and a second element component, basically stirrup shaped, for retaining the airbag between the two element components. The first element section and the second element section are combined to form one open and one closed end of the fastening device, with at least one of the two element components equipped with holding devices, providing for a secure pre-installation of the fastening device to the airbag.

The subject invention concerns a fastening device for the installation and retaining of an airbag to the vehicle's body.

For some time, vehicles have been equipped with airbags, initially only for the driver's protection, then later to protect the passenger. For a long period of time, protection was aimed at the effects of a frontal collision. Airbags were installed in the steering column, and later also as replacement for the glove compartment, and were designed to prevent the driver's, and later the passenger's head, from shooting to the front in the event of a frontal collision.

Recently, vehicles started to be equipped with airbags intended to safeguard the vehicle's occupants on the sides as well. Aside from individual side airbags, there are also so-called side curtain-type airbags, fastened to the vehicle's body in a top, lateral bar, giving protection to one or several seats in a row. When folded, these airbags can measure up to approximately 2 m for installation and are fastened to the respective bar with several fastening elements.

The publication EP-A-1 502 828 describes a clip for fastening such side curtain-type airbag to the vehicle's body. Essentially, this clip consists of two parts. The first, casing-like component is intended to be put into an opening created in the body, catching on the vehicle's body. Then, a fastening loop for the airbag will be put onto the opening, and an installation flange with a through hole will be put on top of the airbag strap.

Subsequently, a second, pin-like, complex-shaped component of the clip will be pressed into the borehole of the mounting flange and into the opening in the body, to prevent the first, casing-like component of the clip from slipping out of the body. If the airbag is to be fastened with several clips, the mounting flange can extend over several openings.

Installation of a side curtain-type airbag with the existing kind of clip and the method of installation require experience, and usually, due to the limited time available for installation, a second mechanic holding the airbag in place while the first mechanic presses the pin-like components of the clip into the casing-like clip components, that were installed prior during a previous step.

The purpose of the invention is to provide a fastening device, enabling a simpler installation which can be carried out by a single mechanic. An even and wrinkle-free installation of the airbag should be possible.

The invention's task is solved with a fastening device according to patent claim 1.

Advantageous results of the subject fastening device are covered by sub-claims.

The subject fastening device is configured in such manner that it not only serves the fastening of an airbag to a vehicle's body, but also the retention of the airbag, holding the folded airbag securely in place until inflated. Furthermore, the fastening element is built in such manner, that it can be pre-installed to the airbag, so that a single mechanic is capable of mounting the airbag quickly and evenly, in particular wrinkle-free, to the vehicle's body.

The above mentioned characteristics and advantages of the subject fastening device are based on employing an essentially flat first element component for the immediate fastening of the airbag to the vehicle body and a second component of the element located above, essentially clamp-shaped, with first and second element component forming one joint open and one closed end of the fastening device. Furthermore, the fastening device includes holding devices that can be formed in at least one of the two components, allowing for a secure pre-attachment of the fastening device to the airbag.

The subject fastening device can be manufactured as a single piece, but can also consist of a second component, separate from the first component of the element. Also, the fastening device can be manufactured either out of metal or of plastic. Unless fabricated as a single piece, the device also can have one component out of metal, with the other component out of plastic.

Whenever the fastening device is delivered for pre-installation, the open end of the fastening device is sufficiently open for the placement of a folded airbag without a problem. As a rule, the airbag is contained in a thin casing, easy to tear by the pressure of the filling of the airbag, and includes a fastening strap, used for attaching the airbag to the holding devices that are an integral component of the fastening device. Depending on the type of clip, the retaining devices are shaped as punched noses, patterned guides or other punches and stamps formed, protruding from the first and/or second component of the fastening device. But they can also be present in the form of additional casings or rivets. In some variations, the holding devices, at least partially, also serve for holding together the airbag after the clip was inserted.

To properly serve the combined function of fastening and retaining, together with simplified mounting, as easily as possible, the two components of the fastening element are joined together at the closed end with two attachments forming a joint edge, and shaped similarly. In single piece metal versions of the fastening device, the joint edge is a lock seam. In single plastic piece versions, the joint edge is a film hinge or a compound enhancing the relative elasticity of the two components to each other.

In comparison, the single piece version has the advantage that simple means of fastening can be formed at the fastening device which securely hold together the two device components when compressed, after the airbag has been inserted, so that the airbag cannot slip out of the fastening device. In the two piece version, additional devices or shapes have to be provided for keeping together the two element components. Both types, however, allow the pre-assembly of the airbag restraining device and fastener for the simple installation in the vehicle's body. Pre-installing of fasteners—such as box nuts—in the vehicle body is not required.

In principle, fitting the subject fastening device without these types of attachments is also possible. This, however, implies that the mounting device will have to be applied or formed on the first section of the element, underneath the second element section, which in turn renders the accessibility of the mounting device, in particular for the version of the fastening device with box nut described further down, to be rather limited. That type of fitting will only be of advantage when extremely limited space is available for the mounting of the airbag, and in particular, the mounting of the pre-installed fastening elements.

The following describes the subject fastening device in two differing design versions. The first design requires mounting the fastening device to the vehicle's body with a screw connection, whereas the second design is strictly a clip-on version.

The first version of the fastening device calls for the two joints to be formed essentially flat, provided with a through hole through both joints. The joint of the first element section is provided on the far side of the other joint with a guide, protruding from the fastening device, and covering essentially a surface parallel to the first section of the element, which is equipped with a box nut. The distance between the first element section and the guide correlates approximately to the thickness of the bodywork at the location where the fastening device is to be mounted. During the installation of the fastening device, the guide of the fastening device will be guided into an opening provided in the vehicle's body so that it will rest on the back of the bodywork, and that the fastening device will include the bodywork between the first section of the element and the guide. The subsequent placement of a screw will penetrate these two joints of the first and the second element sections, the bodywork, the airbag loop in between, and finally the guide, before reaching the box nut.

As a rule, side curtain-type airbags are installed in essentially vertical surfaces of the body. For a fastening device installed in the opening provided in the body, with the guide carrying box nut extending towards the common edge of the joints, not to slip out of the opening, and for the mechanic to be able to initially place all fastening components into the openings provided prior to placing the individual screws and tightening them, in particular for an airbag with several of these pre-installed fastening devices, the first element section is equipped with a patterned guide on the side opposite the second element section, extending towards the guide, which will be supported by snapping into place at the edge of the opening opposite the box nut, after successful mounting of the fastening device in the opening provided for mounting.

It is of advantage, but not essential, that the free end of the first element section is angled away from the second element section.

Additional design for the first version of the subject fastening device includes two noses on the first element section facing the second element section, fitting into two corresponding openings in the second element section after placement of the airbag in the fastening device and the compression of the two sections, which also are bendable for the purpose of keeping the two sections together. The two noses can serve both for the fastening of the airbag to the fastening device and the pre-installation of the fastening device to the airbag. For that purpose, the loops formed on airbag case as mentioned further above, will be hung onto the noses, or attached to noses with pre-fabricated holes. Afterwards, the two components will be compressed, and the noses will be bent, in order to keep the two elements sections pressed together. For the invention, the device including noses can also be used for the second described version, as well as other additional versions.

In accordance with another version of the fastening element, the second element section possesses at least two, ideally four noses directed towards the first element section, which will be in place tightly after the installation of the airbag to the fastening element, and the compression of the two sections on top of the first section, in order to keep in place the loop of the airbag, inserted between the two element sections. This concept can be used for the two versions described herein, as well as other versions of the device.

The second version, purely a clip version, shows the fastening device with a clamp at the open end, lengthening the first section in an angle, facing away from the second section. This clamp also has two V-shaped sides facing one another, creating a spring force, which will be inserted into an opening in the body during the mounting of the fastening device, clicking into place. Furthermore, the formulations of the first and the second element sections include a section with at least the start section of the first element component reaching into a level parallel to the first section after the mounting of the fastening element to the body. The distance of the parallel level to the first element section is calculated in such manner that after the insertion of the closed end of the fastening device in an opening in the body, the section of the start of the first element section, together with the corresponding section of the start of the second element section laying on top will rest on the back of the body work.

For the latching of the two element sections after the mounting of the air bag, both the first and the second element sections are provided with a latching guide in the region bordering the respective beginnings. The two guides are shaped in such manner that they will form a latch holding together the two element sections after the mounting of the airbag in the fastening device, and after the compression of the two element sections.

In the version described herein, the first element section is provided with a first guide in the region bordering the respective starting point, bent towards the second element section. In addition, the second section of the element is provided with a second guide in the region bordering the respective attachment, extending towards this attachment and towards an opening for the insertion of the first guide. Both latching guides are formed in such manner that they will form a retaining latch for the two element sections after the mounting of the airbag to the fastening device and the compression of the two element sections.

The fastening device also is provided with an angled locking guide at the closed end of the first element section, on the side away from the second element section, extending beyond the common joint, which will prevent a cover being installed to the body in case the fastening device was not installed properly.

In this measure, mostly affecting the clip version, the locking guide and the V-shaped latching clamp located on the other side, each form an independent safeguard against improper mounting, on one hand by the distance between first element section and body, enforced by the locking guide in case the fastening device was not inserted properly into the hole provided, and on the other hand by the retraction and the transverse positioning of the fastening device, in case the V-shaped latching clamp is not inserted completely into the opening provided, or completely compressed. In both cases, a subsequent mounting of the roof covering or any other type of cover is no longer possible.

With incorrect installation of the version with screws, the screw can no longer be installed with the help of a torque control screwdriver, since the hinge moment cannot be reached due to the missing nut and will be indicated as fault.

The second element section is provided with a border reaching from the closed end of the fastening device along the lengthwise edges, protecting the inserted airbag, but at least without ridges, directed away from the first element section.

The fastening device can alternatively be punched out of sheet metal, produced by folding, or by plastic spray process.

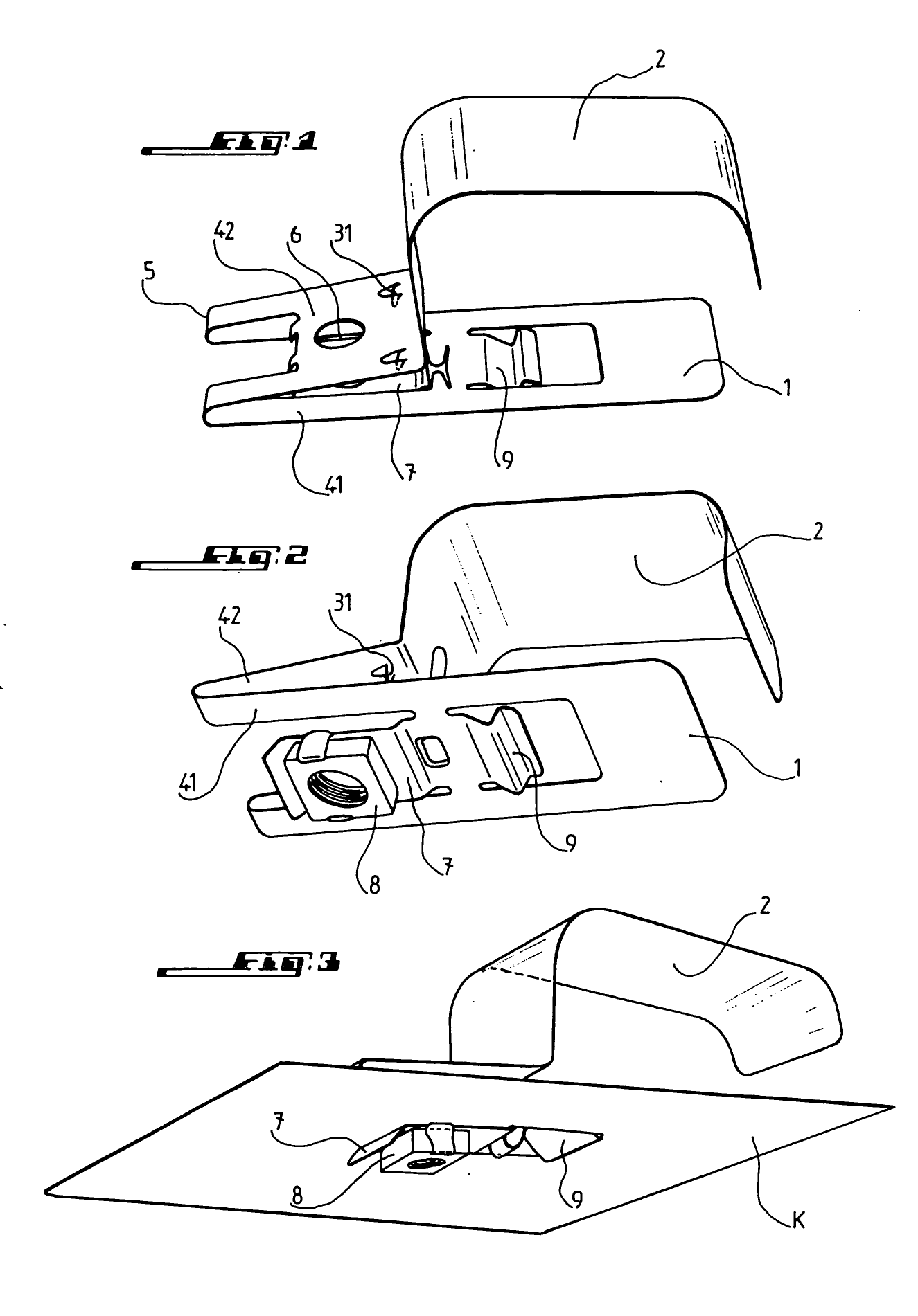

FIGS. 1 through 3 show the subject fastening device in the first version,

FIG. 4 shows the subject fastening device in the second version, and

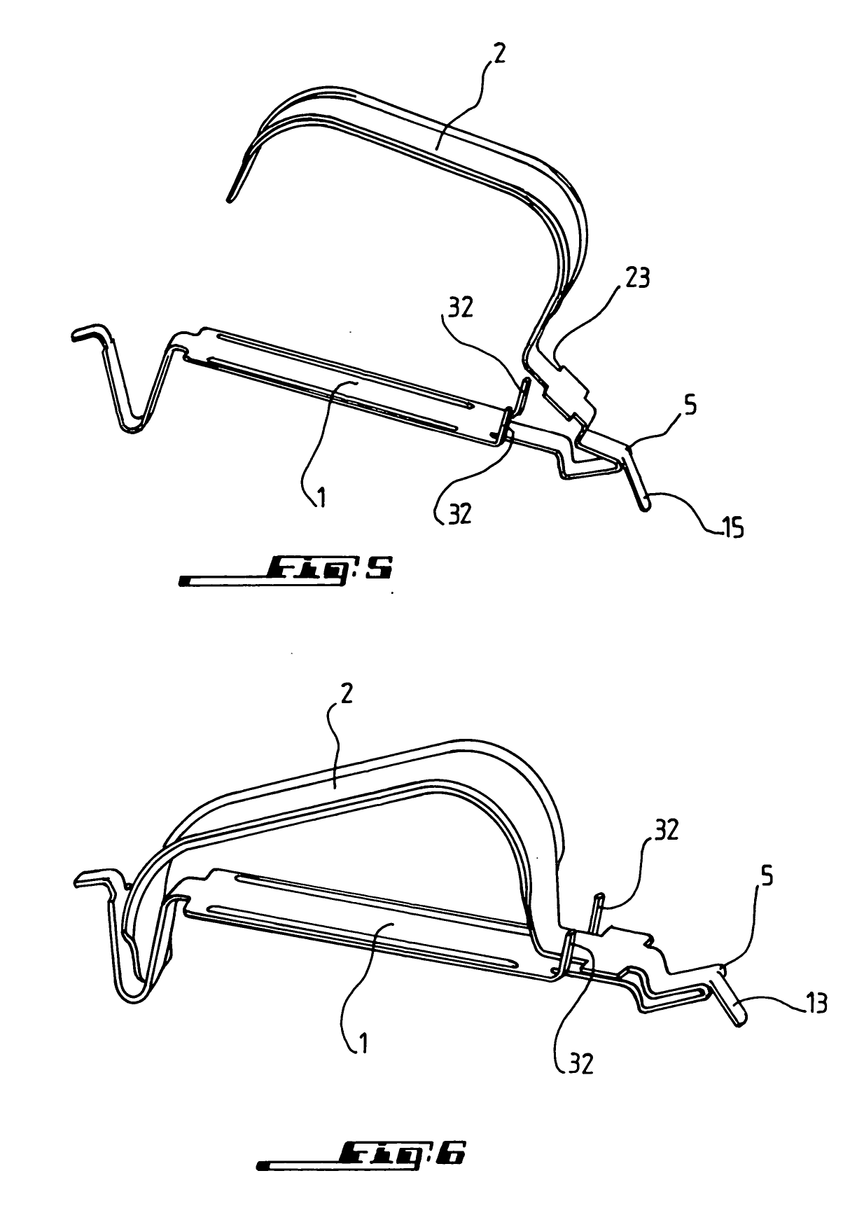

FIGS. 5 through 6 show the subject fastening device in a variation of the second version.

FIGS. 1 and 2 show a fastening device in a first version of the invention. The fastening device is equipped with an essentially flat first element component 1 for the immediate fastening of the airbag to the body and an essentially stirrup-shaped second element component 2 located above, for the retention of the airbag between the two element components. Element section 1 and second element section 2 together form one open and one closed end of the fastening device. At least one of the two element sections is equipped with holding devices, so that the fastening device can be pre-installed at the airbag without risk of loss. The two element components 1 and 2 are connected at the closed end with two essentially equally shaped and essentially flat shaped attachments 41, 42, forming a folded joint.

Both attachment 41 and 42 are provided with a through hole through both joints, with attachment 41 of the first element section 1 provided with a guide 7 protruding from the fastening device and covering essentially a surface parallel to the first element section 1, equipped with a box nut 8 on the far side from attachment 42. In addition, the first element section 1 is provided with a latching guide 9, directed away from second element section 2 and box nut 8.

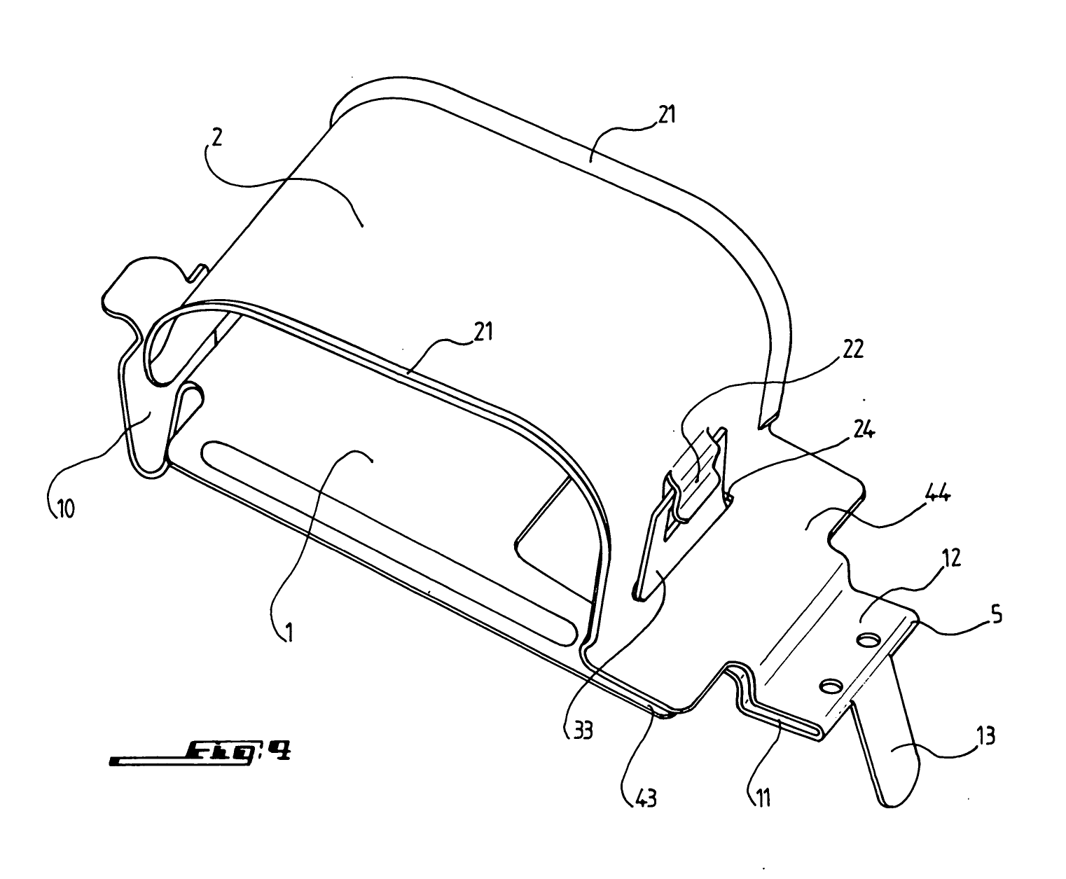

FIG. 3 shows the fastening device of FIGS. 1 and 2 after the installation in vehicle body K. FIG. 3 confirms an essential advantage of the subject fastening device, already seen in FIG. 2: the nut required for the fastening of the fastening device in this version is installed as box nut 8 to the fastening device and does not require to be installed prior, in a separate job, at the back of the body. Another advantage is the fact that the fastening device is already retained by latching guide 9 prior to attachment with screws to the openings in the body, facilitating the installation of the airbag.

FIG. 4 shows a fastening device in the second version of the invention. This fastening device—just as the fastening device described previously—essentially is equipped with a flat first element section 1 and an essentially stirrup-shaped second element section 2, located above, with borders 21 along the lengthwise edges, as well as retainer 33, providing for the secure pre-installation of the fastening device to the airbag. The two element components 1 and 2 are connected at the closed end with two essentially equally shaped, essentially flat-formed attachments 43 and 44, forming folding joint 5.

Furthermore, the fastening device is equipped with a latching clamp 10 at the open end of the first element section 1, angled and elongating, directed away from the second element section 2, and the two attachments 43, 44 of the first and the second element sections respectively are equipped with sections 11 and 12, with at least section 11 of attachment 43 of the first element component 1 extending into a level parallel to the first element component after mounting the fastening device to the body.

For locking element components 1 and 2, each is equipped with a locking guide 33, 22, with locking guide 22 punched out of the second element component 2, and shaped for receiving locking guide 33. Locking guide 33 is punched out of the first element component 1 and shaped in such manner that it can be inserted through opening 24 provided in the second element component 2, being pushed underneath locking guide 22, which in turn will latch to locking guide 33. The two locking guides 33 and 22 are formed in such manner that they will form a retaining latch for the two element sections after the mounting of the airbag to the fastening device and the compression of the two element sections.

In addition, the fastening device is equipped with an angled blocking guide 13 at the closed end of the first element component 1, reaching beyond lock seam 5, on the side away from the second element component 2, which will prevent the installation of a cover for the airbag in the vehicle's body in the event the fastening device was not installed properly. For example, if only latching clamp 10 is latched to the opening provided in the body, the length of blocking guide 13 results in the excessive mounting height of the fastening device, and thus prevents the mounting of the covering.

FIGS. 5 and 6 show a variation of the fastening device in FIG. 4, with the width of the opening prior to mounting of an airbag (FIG. 5), and/or after compression of the element components, with no airbag installed. In that manner, FIG. 6 shows the bias for retaining the airbag in the fastening device.

FIGS. 5 and 6 depict holding devices 32 for fastening the airbag to the fastening device. These holding devices in shape of noses will reach into two respective openings or sections 23 of the second element component 2, after the placement of the airbag in the fastening device and the compression of the two element components 1 and 2, which then will be bent in default direction, essentially towards edge 5, for the purpose of keeping the two element components together.

1. Fastening device for the installation and the retaining of an airbag to the vehicle's body, with the fastening device equipped with an essentially flat first element component for the immediate fastening of the airbag to the body and a second element component, basically stirrup shaped, for retaining the airbag between the two element components, with first element component and second element component forming an open and a closed end of the fastening device, with the formation of holding devices in at least one of the two element components, which provide for a secure pre-installation of the fastening element to the airbag.

2. Fastening device in accordance with claim 1, wherein the two element components are joined together at the closed end with two attachments forming a joint edge, and shaped essentially similar.

3. Fastening device in accordance with claim 1, wherein the two attachments are shaped basically flat and provided with a through hole through both attachments, with the attachment of the first element component equipped with a guide, protruding from the first fastening device and extending in a level parallel to the first element component, with the guide equipped with a box nut on the side away from the other attachment.

4. Fastening device according to claim 3, wherein the first element component is equipped with a latching guide, extending away from the second element component and the box nut.

5. Fastening device in accordance with claim 3, wherein the first element component is angled at the open end of the fastening device, away from the second element component.

6. Fastening device in accordance with claim 3, wherein the first element component is equipped with two noses, facing the second element section, fitting into two corresponding openings in the second element section after placement of the airbag in the fastening device and the compression of the two element components, which also are bendable for the purpose of keeping the two sections together.

7. Fastening device in accordance with claim 3, wherein the second element component is equipped with a minimum of two noses directed toward the first element component, which will securely lay atop the first element component after the mounting of the airbag to the fastening device and the compression of the two element components.

8. Fastening device in accordance with claim 1 further comprising a latching clamp at the open end, angled, and elongating the first element component, directed away from second element component, and wherein the two attachments of the first and the second element component each are equipped with a section, with the section of attachment of the first element component at a minimum extending to a level parallel to the first element component after the mounting of the fastening device to the body.

9. Fastening device according to claim 8, further comprising a latching guide in a region bordering the respective attachments of the first element component and the second element component, with the two locking guides formed in such manner that they will form a retaining latch for the two element components after the mounting of the airbag to the fastening device and the compression of the two element components.

10. Fastening device in accordance with claim 8, wherein the first element component is equipped with a first latching guide in the region bordering the respective attachment, bent towards the second element component, and that the second section of the element is provided with a second latching guide in the region bordering the respective attachment, extending towards this attachment and an opening for the insertion of the first latching guide with the two locking guides formed in such manner that they will form a joint retaining latch for the two element components after the mounting of the airbag to the fastening device and the compression of the two element components.

11. Fastening device in accordance with claim 8, further comprising an angled blocking guide at the closed end of the first element component, extending beyond the common edge on side away from second element component which will prevent the mounting of a covering for the airbag to the body in the event of improper installation of the fastening device.

12. Fastening device in accordance with claim 1, further comprising longitudinal edges with borders along the second element component, protecting the airbag placed into the fastening device by being free of lines or directed away from the first element component, extending from the open to the closed end of the fastening device.

13. Fastening device in accordance with claim 1, which is produced by punching out sheet metal and folding.

14. Fastening device in accordance with claim 1, which is produced by a plastic spraying method.

15. Fastening device in accordance with claim 1, wherein one of the two element components is manufactured of plastic, and the other component, is manufactured of metal.
